(19) United States
(12) Patent Application Publication
(10) Pub. No.: US 2023/0241429 A1
(43) Pub. Date: Aug. 3, 2023

(54) MASK HAVING LAYERS OF SYNTHETIC HAIR, MUCUS AND MUCIN TO TRAP MICROBES

(71) Applicant: VLN Biotech Inc., Ottawa (CA)

(72) Inventors: Mohan Vijay, Ottawa (CA); Sheela Vijay, Edmonton (CA)

(21) Appl. No.: 18/163,049

(22) Filed: Feb. 1, 2023

Related U.S. Application Data
(60) Provisional application No. 63/305,506, filed on Feb. 1, 2022.

(51) Int. Cl. A62B 23/02; A41D 13/11

(52) U.S. Cl. CPC A62B 23/025; A41D 13/1192; A62B 18/084

(57) ABSTRACT

An antimicrobial face mask antimicrobial face mask comprising ear-loop straps to loop around ears of a user, an inner layer of fabric, a layer of hair adhered to the fabric, a layer of synthetic mucus, a layer of synthetic mucin and an outer layer of fabric that adheres to the synthetic mucus and synthetic mucin.

### TECHNICAL FIELD

The present invention relates generally to face masks and respirators and, in more particularly, to antimicrobial face masks.

### BACKGROUND

The current state of the art of masks is well summarized in the following paragraph, taken from the review article by Ju, J. T. J, Ju, L. N. Boisvert and Y. Y. Zuo, “Face Masks against Covid-19: Standards, efficacy, testing and decontamination methods,” in Adv Colloid Interface Sci, 2021 June: 292: 102435 (with 152 references).

The current theory is that the virus is transmitted by the respiratory droplets, with sizes ranging from 5 μm to 10 μm which are discharged when an infected person coughs or sneezes. That is, the virus is infused in the droplets. It is also known that the infected droplets can travel more than 6-ft, the social distancing, basically followed in all countries. Therefore, masking using low-cost masks have been either enforced or recommended to abate the spreading of the virus. There are a variety of masks available in the market. Some of these are meant for the health care providers and the others for general public. The most important property of a mask is the porosity as this determines the efficacy of filtration of the mask. According to NIOSH (National Health for Occupational Safety and Health; USA), among others (for example, CDC (Centre for Disease Control, USA), recommend masks that filter particles which are less than 1 μm in size. The average size of Coronavirus particle is 0.12 μm (120 nm). However, the pore size of the most popular mask N95 varies from 0.1 to 0.3 μm. Therefore, N95 cannot stop the transmission of the Coronavirus unless it is encapsulated in a droplet as stated above. Wearing a mask adds a layer of defence in addition to the natural defences of the human which include the hair and the mucus in the membranes of the nose that is able to trap microbes (see FIGS. 1 and 2).

### Description of Prior-Art Masks

As shown in FIG. 3 (the photos and sketches are taken from the internet; “The best face masks for virus protection for 2021” by A. Carnegie, EDC—Environmental Design+Construction), a variety of face masks are available in the market for protection against the virus.

TABLE 1
Characteristics and specifications of the masks listed in FIG. 3.

| Mask | Characteristics and specifications |
|---|---|
| 3M 8511 N95 | It is certified by NIOSH. It can effectively trap particles >0.3 μm (3,000 |
| | nm). It is equipped with CoolFlow valve and an adjustable metal nose |
| | clip. The valve helps to expel heat and water vapor from the breath. |
| | The clip appears to be a good seal around the face. The elastic band |
| | appears to be tight for some individuals. |
| Coopower disposable | It is fabricated from three layers of non-woven soft fabrics with metal |
| face masks | nose clip for sealing around the mouth and nose and elastic band. The |
| | cost per mask is quite low compared to other types of masks. |
| | However, not certified as effective to block viruses. |
| Honeywell nuisance | Although very comfortable to use to block airborne contaminated |
| disposable dust mask | particles. It is not certified by NIOSH for use against the viruses. |
| 3M 1860 medical | The mask is fabricated from soft, comfortable, and hypoallergenic |
| mask N95 | materials. The heat buildup inside the mask can be uncomfortable. It |
| | is also fairly expensive (e.g. US$1.77/mask). |
| Disposable face mask | It is comfortable to wear. Although not certified, does block airborne |
| 3-ply breathable | particles, not viruses. This is the most common mask given to the |
| filter safety mask | visitors at the hospitals. |
| Dynarex 2201 medical | The mask is fabricated from medical-grade materials and therefore |
| surgical face mask | can trap most airborne particles. It is not certified for viruses. |
| SolidWork foldable | The mask has an exhalation valve to remove the heat. Can trap most |
| respirator mask | airborne particles, not necessarily viruses. As it is soft, it is quite |
| | comfortable to wear long periods. Approved by NIOSH and rated as |
| | N95. It is not approved by CDC (Centre for Disease Control and Prevention). |
| GVS SPR451 Elipse P100 | A P100 rating is the highest for personal respiratory protection. This |
| Half Mask Respirator | N95 respirator is fabricated from 100% silicone and as such it is |
| | completely hypoallergenic and quite soft. It also has a downward |
| | pointing exhalation valve, eliminating fog on the glasses and keeps |
| | inside of the mask dry and cool. It will effectively block particles 0.3 |
| | microns (3,000 nm) or larger. It is meant for working environment and |
| | not for general public. Fairly expensive (.$30, with replaceable filters). |
| Kimberley Clark Fluidshield | ASTM F2100-11 Level 3 rating for heavy fluid protection, the |
| Procedure Face Mask | maximum level of fluid resistance recognized by ASTM F2100-11. It |
| | comes with ear loops for easy donning and secure fit. The breathable |
| | film and so soft lining are designed to resist fluid penetration upon |
| | impact. Fog-free with a foam strip for comfort and protection. |
| Universal 4530 heavy duty | Although not approved by NIOSH, it fits the face quite well. It is quite |
| non-toxic safety mask | lightweight and breathable. Comfortable to wear long periods of time. |
| | The single strap keeps the mask in place. |

Although these masks provide some degree of protection, an improved mask is highly desirable to combat the spread of coronavirus.

### SUMMARY

In general, embodiments of the present invention provide a mask having a layer of hair and a layer of mucin or synthetic mucous to block microbes such as viruses.

One main inventive is an antimicrobial face mask antimicrobial face mask comprising ear-loop straps to loop around ears of a user, an inner layer of fabric, a layer of hair adhered to the fabric, a layer of synthetic mucus, a layer of synthetic mucin and an outer layer of fabric that adheres to the synthetic mucus and synthetic mucin.

The foregoing presents a simplified summary of the invention in order to provide a basic understanding of some aspects of the invention. This summary is not an exhaustive overview of the invention. It is not intended to identify essential, key or critical elements of the invention or to delineate the scope of the invention. Its sole purpose is to present some concepts in a simplified form as a prelude to the more detailed description that is discussed later. Other aspects of the invention are described below in relation to the accompanying drawings.

### BRIEF DESCRIPTION OF THE DRAWINGS

Further features and advantages of the present technology will become apparent from the following detailed description, taken in combination with the appended drawings, in which:

FIG. 1 is a photo showing nasal hair inside human nostrils.

FIG. 2 is a sketch of the human respiratory system.

FIG. 3 is a series of images showing various types of prior-art masks.

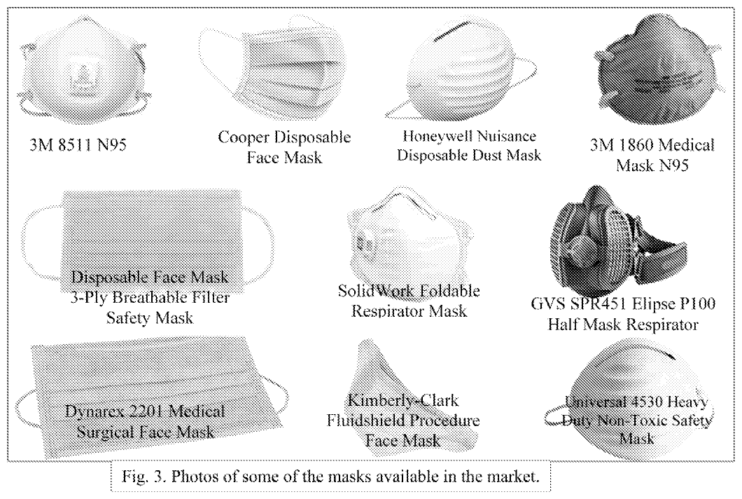

FIG. 4 is a plan view of antimicrobial pad usable to create an antimicrobial mask having strands of synthetic hair.

FIG. 5 is a front view of a mask having synthetic mucus and mucin adhered to a silk layer.

FIG. 6 is a cross-section view of a mask having mulberry silk, hair strands, synthetic mucus, synthetic mucin.

FIG. 7 is a front view of a mask having hair, synthetic mucus and synthetic mucin.

FIG. 8 is a view of a mask showing shafts of synthetic hair.

FIG. 9 is a view of mas having mulberry silk, hair strands, synthetic mucus, synthetic mucin.

It will be noted that throughout the appended drawings, like features are identified by like reference numerals.

### DETAILED DESCRIPTION

Disclosed herein is a novel antimicrobial face mask that includes hair and synthetic mucus or mucin to block microbes such as viruses. The face mask, which is also known as a respirator or respiratory protective device, is designed to cover the mouth and nose and to filter microbes such as viruses.

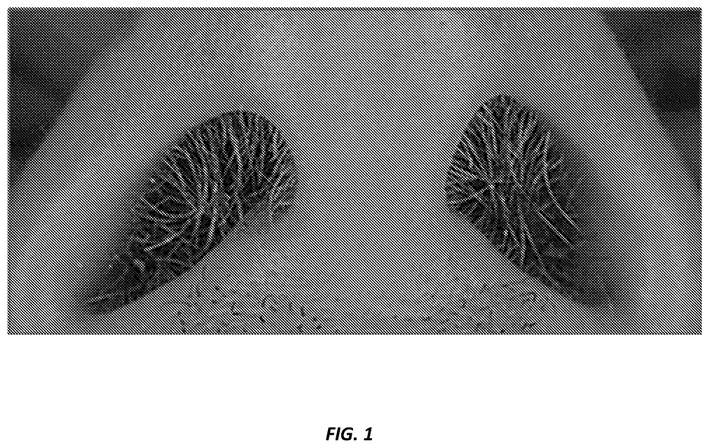

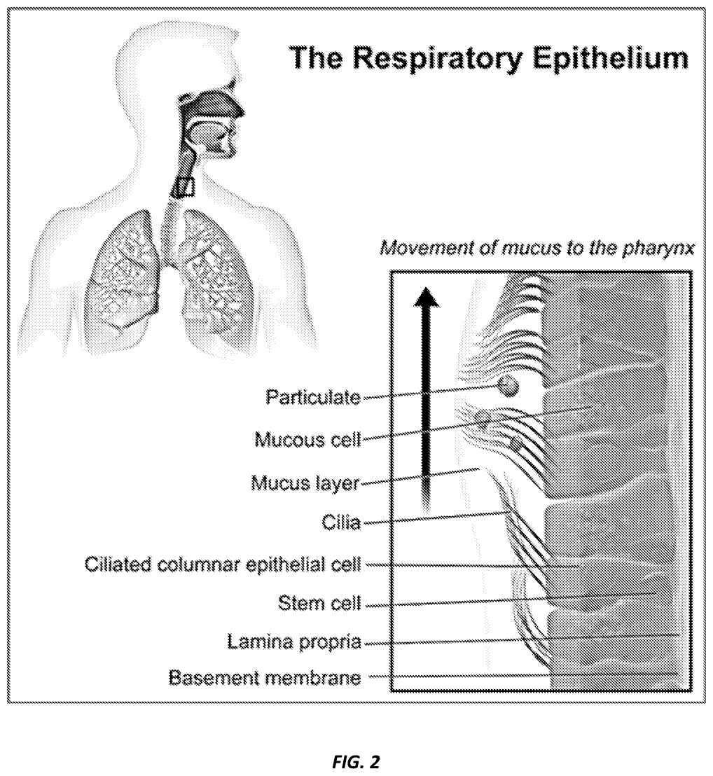

The present invention uses hair and synthetic mucus to function like the hair and mucus in the membranes of the nose to trap the microbes (see FIGS. 1 and 2). Briefly, mucus is over 90 percent water, but it also contains fat, salts, proteins, various immune cells, and mucins. A mucin is a protein covered in chains of sugars that stick out from the mucin molecule like legs on a centipede. Mucins give mucus its slippery feel and are very effective at binding together to form gels, which enables mucus to create a strong barrier against microbes and irritants. Mucus performs several important functions to keep the body safe from infection. New microbes constantly attempt to invade the human body, many of them disease-causing pathogens. When fragile parts of the epithelium—the outer layer of skin and the linings protecting organs—crack, microbes have an easy access point. To prevent this, mucus keeps the epithelium well-lubricated. Mucus also coats the existing entry points into the body, such as the nose and mouth catching pathogens that try to get in that way. The mucins form a powerful sticky mesh, like a glue trap that the invading microbes get stuck in, preventing them from moving any farther into the body. Then antibodies, immune cells, antimicrobial proteins, and bacteria-infecting viruses contained in mucus can kill the pathogens or isolate them to prevent them from building up.

The antimicrobial mask in accordance with some embodiments of the present invention includes a pad (a layer or ply) impregnated with synthetic mucin (Ref: “Mucus and Mucins may become the medicine of the future,” Jul. 7, 2021, The Faculty of Health and Medical Sciences, University of Copenhagen).

The efficacy of the hairs in the nostrils to trap the microbes depends on the density, that is, the number of hairs per unit area of the skin. The density and diameter of the hair depends on the age of an individual. A search on the website indicates that a baby has higher density than the adults and the hair is quite soft. The diameter of the hair apparently varies from 17 to 181 μm, the average being 99 μm. Based on this approximation, the hair density in the nostril is of the order of 130/mm². The distance between two adjacent hair shafts is approximately 100 μm, which is far greater than the average size of coronavirus. Therefore, the natural hair in the nostrils does not trap the virus.

A sketch of the respiratory system is depicted in FIG. 2. As shown indicated in FIG. 2, the structure of the nose is quite complex. From the standpoint of this invention, the most important aspects are the mucus and mucin, particularly synthetic mucin. There are numerous articles on this topic (for example, “With synthetic mucus, researchers take aim at antibiotic resistance” Science Daily, April 2017; “Pharmaceutical composition for preventing, treating, and curing psoriasis including snail slime, chamomile and honey” US Patent No.: US 2017/0216368 A1, August 2017; “Thermo-physical properties of synthetic mucus for the study of airway clearance,” by Lafforgue, et. al., J of Biomedical Materials Research Part A, Wiley 2017, 105 (11); “The benefits and risks of using snail slime products on your face and skin: a conclusive guide, April 2017; “Synthetic mucus can mimic the real thing” by A. Trafton, MIT, PHYS.org, March 2021; Snail slime: the science behind mollusks as medicine” by S., Pitt, November 2019, Medical Press; “Snail slime composition: natural assets of the snail slime” Royer Cosmetique & Maisson Royer, February 2021; “Snail slime” in Wikipedia, March 2021; “What is snail mucin and does it really work on skin?” by R. Stemers in Beauty; “Mucus and mucins may become the medicine of the future” Science News, July 2021; “Human respiratory mucins” by G. Lamblin et. al., Eur Respir J., 1992; “Antimicrobial properties of terrestrial snail and slug mucus” by G. Cilia and F. Fratini, J of Complimentary and Integrative Medicine, 2017; “Advancing discovery of snail mucins function and application” by M. McDermott et. al., Front Bioeng Biotechnology, October 2021; “Therapeutic and cosmetic compositions for treatment of skin” U.S. Pat. No. 5,538,740, July 1996). These documents are hereby incorporated by reference.

As described above, most of the prior-art masks seem to be satisfactory for blocking the infected airborne droplets or particles of the order of 3 μm (3,000 nm). However, the size of a coronavirus is of the order of 0.12 μm (120 nm). If they are free floating in the air, then the prior-art masks are not effective in stopping them. Furthermore, the prior-art masks do not take advantage of the benefits offered by nature, namely mucus/mucin and the nasal hair by using synthetic mucus/mucin and the synthetic or natural human hair, such as nasal hair. The present invention has multiple implementations: (1) it can be just a pad, fabricated from pure (mulberry) 250 μm thick silk, that can be inserted into any of the existing masks with slight modification to the design or (2) a new mask shaped to fit the face and having ear-loop straps.

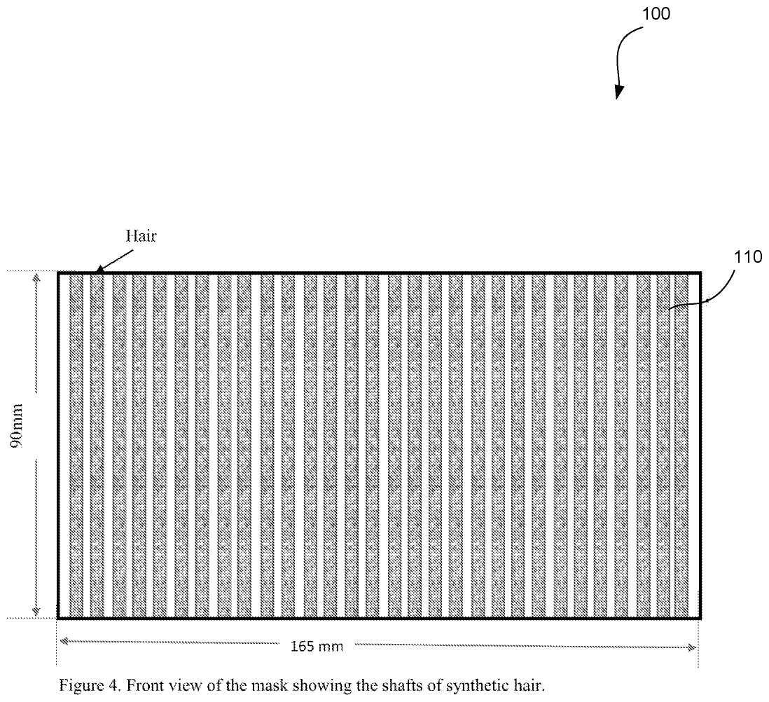

FIG. 4 shows an embodiment of the invention in a configuration as a pad 100 having a plurality of strands of hair 110. The pad may be inserted into an existing mask or be assembled with ear-loop straps to form a complete mask. The hair may be natural hair or synthetic hair. The synthetic hair may be made of fibers like acrylic or nylon. Although the diameter of the hair varies, in this embodiment of the invention shafts of 50 μm (50,000 nm) in diameter are selected. The dimensions of 90 mm×175 mm shown in FIG. 4 are exemplary only and may be varied. The strands are shown as being parallel in this embodiment although non-parallel or intersecting strands are possible in other embodiments. In FIG. 4, the hair shafts are glued, bonded or otherwise adhered to the silk using an adhesive, preferably a biocompatible adhesive such as artificial fibrin glue made from thrombin and fibrinogen (source: Internet article on Thrombocyte). Alternatively, a new synthetic adhesive, called MAR-1, can be used (Source: Srinivasan, P. K., et al., “Novel synthetic adhesive as an effective alternative to Fibrin based adhesives,” World J Hepatol, 2017, Aug. 28), which is hereby incorporated by reference. Both of these adhesives are believed to be biocompatible.

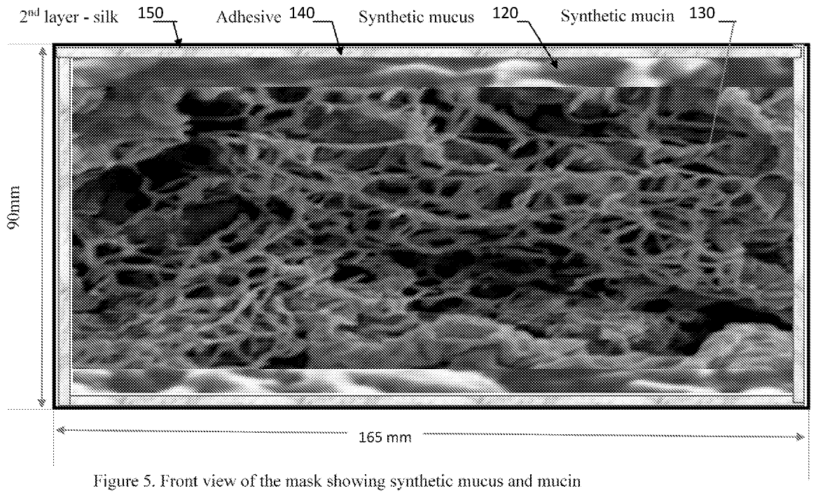

FIG. 5 shows the second layer 150 of silk smeared or coated with synthetic mucus 120 and synthetic mucin 130 (which in one embodiment may have a total thickness of 100 μm). The synthetic mucin is laid over the layer of synthetic mucus. This second layer (combined mucin-mucous layer) is glued to the first layer of hair using the adhesive 140 mentioned above.

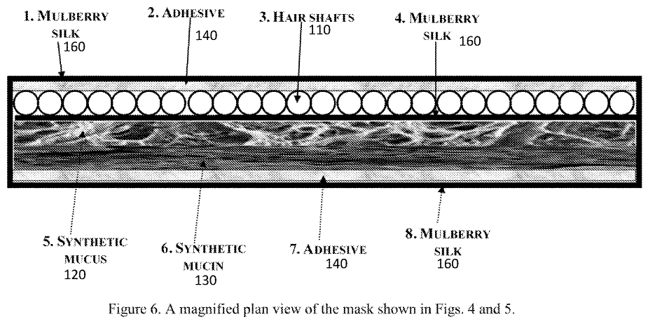

For further clarification, FIG. 6 shows a magnified cross-sectional view of the mask of FIG. 4 and FIG. 5 in accordance with an embodiment of the present invention. As depicted in FIG. 6, the mask has a first layer of mulberry silk 160, an adhesive layer, a layer of hair, a further layer of mulberry silk, a layer of synthetic mucus, a layer of synthetic mucin, further layer of adhesive and finally a layer of mulberry silk. Mulberry silk is known to have silk possesses antimicrobial, antiviral, and antibacterial properties

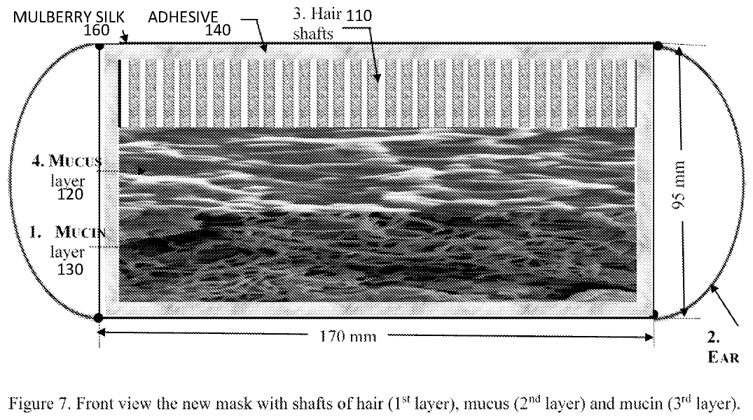

A mask with these above features and further having ear-loop straps (or simply ear loops) is illustrated by way of example in FIG. 7. The basic configuration is like the existing N95 mask or other ear-loop face masks. For the sake of clarity only the following layers are depicted: hair layer, mucus and mucin layers as well as the mulberry silk. The dimensions may be 170 mm×95 mm, for example, which are standard. The edges, as shown in FIG. 7, are coated with the biocompatible adhesive mentioned above. The adhesion is just sufficient to seal the mask around the mouth, nose, cheeks and the chin. The mask may include ear straps which are provided as a safety precaution against strong wind.

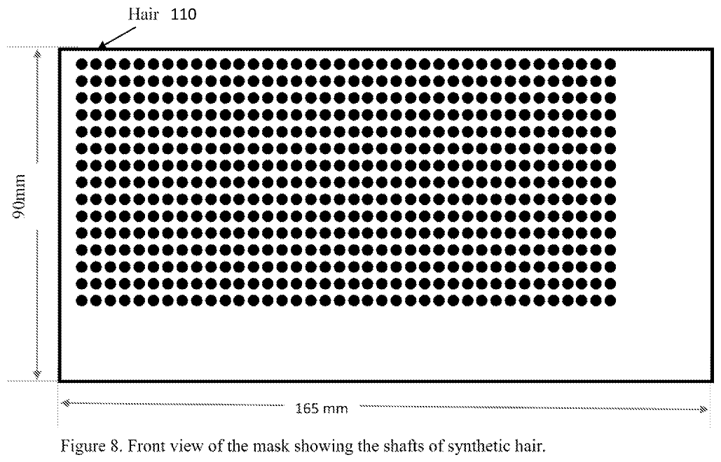

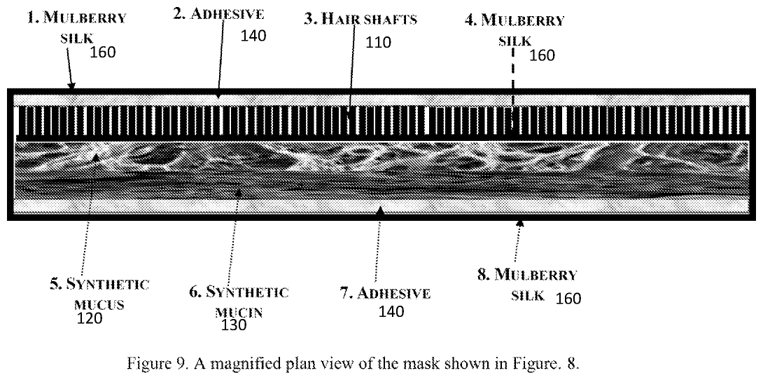

Another embodiment of the present invention is illustrated by way of example in FIG. 8. In the embodiment depicted in FIG. 8, the shafts of hair are inserted in the pores of mulberry silk like a common hairbrush. Likewise, the synthetic mucus and mucin are deposited on the two layers, as illustrated in FIG. 7, on the mulberry silk. A cross-sectional view is depicted in FIG. 9 for clarification. The layer with the hair is near (i.e. proximal to) the face in this embodiment.

In the above embodiments, it is possible to insert check valves into the mask to facilitate exhaling.

For the purposes of interpreting this specification, when referring to elements of various embodiments of the present invention, the articles “a”, “an”, “the” and “said” are intended to mean that there are one or more of the elements. The terms “comprising”, “including”, “having”, “entailing” and “involving”, and verb tense variants thereof, are intended to be inclusive and open-ended by which it is meant that there may be additional elements other than the listed elements.

This new technology has been described in terms of specific implementations and configurations which are intended to be exemplary only. Persons of ordinary skill in the art will appreciate that many obvious variations, refinements and modifications may be made without departing from the inventive concepts presented in this application. The scope of the exclusive right sought by the Applicant(s) is therefore intended to be limited solely by the appended claims.

1. An antimicrobial face mask comprising:
ear-loop straps to loop around ears of a user;
an inner layer of fabric;
a layer of hair adhered to the fabric;
a layer of synthetic mucus;
a layer of synthetic mucin; and
an outer layer of fabric that adheres to the synthetic mucus and synthetic mucin.

2. The face mask of claim 1 wherein the fabric is mulberry silk.

3. The face mask of claim 1 wherein the hair is attached to pores in the mulberry silk.

4. The face mask of claim 2 wherein the hair is attached to pores in the mulberry silk.

5. The face mask of claim 1 wherein the hairs are parallel to each other.

6. An antimicrobial pad for a face mask, the pad comprising:
an inner layer of fabric;
a layer of hair adhered to the fabric;
a layer of synthetic mucus;
a layer of synthetic mucin; and
an outer layer of fabric that adheres to the synthetic mucus and synthetic mucin.

7. The pad of claim 6 wherein the fabric is mulberry silk.

8. The pad of claim 6 wherein the hair is attached to pores in the mulberry silk.

9. The pad of claim 7 wherein the hair is attached to pores in the mulberry silk.

10. The pad of claim 6 wherein the hairs are parallel to each other.
